(19) United States
(12) Patent Application Publication
(10) Pub. No.: US 2012/0179669 A1
(43) Pub. Date: Jul. 12, 2012

(54) SYSTEMS AND METHODS FOR SEARCHING A SEARCH SPACE OF A QUERY

(76) Inventors: Awny K. Al-Omari, Cedar Park, TX (US); QiFan Chen, Austin, TX (US); Tom C. Reyes, Austin, TX (US); Kashif A. Siddiqui, Round Rock, TX (US)

(21) Appl. No.: 12/985,833

(22) Filed: Jan. 6, 2011

(51) Int. Cl. G06F 17/30

(52) U.S. Cl. 707/719; 707/E17.131

(57) ABSTRACT

One example discloses a database management system that can comprise a memory for storing computer executable instructions and a processing unit for accessing the memory and executing the computer executable instructions. The computer executable instructions can comprise a compiler to amortize the execution resource cost of searching a search space corresponding to a received query over a plurality of searches.

### BACKGROUND

Relational database systems store tables of data which are typically linked together by relationships that simplify the storage of data and make queries of the data more efficient. Structured Query Language (SQL) is a standardized language for creating and operating on relational databases.

Relational database systems can have the capability to save a compiled execution plan for an SQL query and to re-use the saved plan for subsequent execution of the same query. Storing the compiled execution plan saves the resource cost (e.g. processing time) of having to repeatedly parse and optimize frequently executed queries. A relational database system typically includes an optimizer that plans the execution of SQL queries.

### BRIEF DESCRIPTION OF THE DRAWINGS

FIG. 1 illustrates an example of a database management system.

FIG. 2 illustrates an example of a query cache table.

FIG. 3 illustrates an example of a flowchart of a method for managing a database system.

FIG. 4 illustrates an example of a flowchart of a method determining a search status.

FIG. 5 illustrates another example of a flowchart of a method for managing a database system.

FIG. 6 illustrates an example of a computer system that can be employed to implement the systems and methods illustrated in FIGS. 1-5.

### DETAILED DESCRIPTION

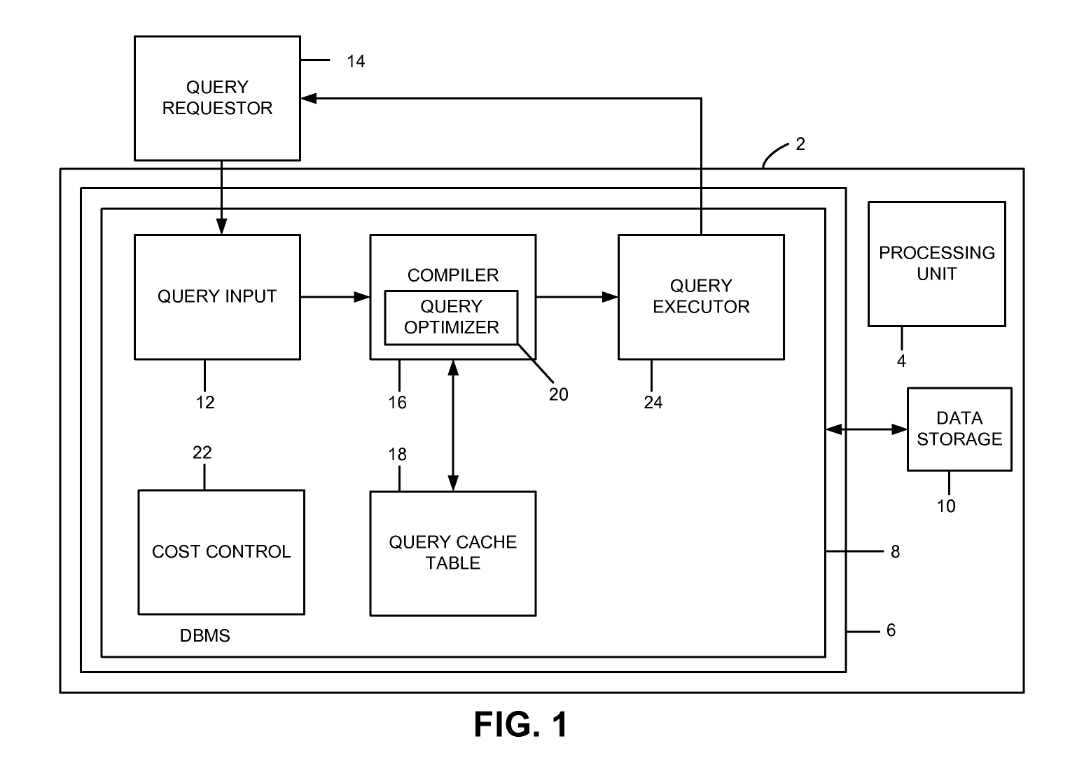

FIG. 1 illustrates an example schematic block diagram of a system 2 for managing a database. Where the disclosure or claims recite “a,” “an,” “a first,” or “another” element, or the equivalent thereof, it should be interpreted to include one or more than one such element, neither requiring nor excluding two or more such elements. The system 2 can include a processing unit 4 and a memory 6. The memory 6 can be employed to store data and computer executable instructions. The processing unit 4 can access the memory 6 and execute the computer executable instructions. The processing unit 4 can include a processing core. The memory 6 can be implemented as a computer readable medium, such as random access memory (RAM), non-volatile memory, etc.

The memory 6 can include a database management system (DBMS) 8 that accesses a database stored in data storage 10. The data storage 10 could be implemented, for example as a computer readable medium, such as a hard disk system, a solid state drive system, random access memory (volatile or non-volatile), etc. The database can be implemented, for example, as a relational database that can be queried using Structured Query Language (SQL).

For purposes of simplification of explanation, in the present example, different components of the DBMS 8 are illustrated and described as performing different functions. However, one of ordinary skill in the art will understand and appreciate that the functions of the described components can be performed by different components, and the functionality of several components can be combined and executed on a single component. The DBMS 8 can include a query input 12 (e.g., a queue) that receives a query from a query requestor 14. The query requestor 14 could be, for example, a system external to the DBMS 8 and/or the system 2, such as an application executing on another computer. For instance, the query requestor 14 could be implemented as a web browser. As one example, the received query can be implemented as SQL relational logic that includes relational operators and/or predicates and literals/constants that define the selectivity of the predicates and/or the relational operators.

The received query can be provided from the query input 12 to a compiler 16 of the DBMS 8. The compiler 16 functions to amortize an execution resource cost of searching a search space corresponding to a received query over a plurality of searches. To perform this function, as one example, upon receipt of the query, the compiler 16 can generate a query cache key based on text and environment settings of the received query. For instance, the query cache key can be based on text of the received query. The query cache key can be implemented, for example as query data that includes the relational logic (e.g., predicates, relational operators, etc.) of the query with literals/constants of the query redacted (e.g. stripped out). Thus, two different received queries that vary in constants/literals and/or predicate selectivity can have the same query cache key. The compiler 16 can access a query cache table 18, which can also be referred to as a query cache, to determine if a stored query cache key has already been generated for the received query. If the compiler 16 determines that no such stored query cache key exists, the compiler 16 can employ a query optimizer 20 to generate a query plan.

To generate the query plan, the query optimizer 20 employs heuristics and/or logic to estimate the most efficient way to execute a query. The query optimizer 20 can generated a search space for a query plan, and attempts to determine which query plan will be the most efficient. The search space is the set of possible query plans employable to execute the received query. The search space can be generated based on a rule set. The rule set can include, for instance, rules and/or a plan that can be employed to enumerate (e.g., expand) members of the search space. For instance, the rule set can include logical operations to enumerate alternate query operations (e.g., query plans) that can be employed to execute the received query. As one example, if a query has a join operation, the rule set can be employed to change the join operation of the received query into a hash-join, a nested join, sort-merge join, etc. for a given member of the search space. In another example, the rule set can be employed to change a scan operation of the received query into an index scan, a sequential scan, etc. for a given member of the search space. In this manner, the rule set can be employed to populate the search space. Furthermore, cost-based query optimizers assign an estimated cost to each possible query plan in the search space and attempt choose the plan with the smallest cost. In such an example, costs can be used to estimate the runtime cost of evaluating the query, in terms of the number of input/output operations required, processing requirements, and other factors determined from a data dictionary.

The search space generated from the rule set can become quite large depending on the complexity of the received query. For instance, for a K-way join query (where K is an integer greater than or equal to one) the search space can be upwards of K! (K-factorial). To increase the speed at which the query optimizer 20 finds an acceptable query plan, the query optimizer 20 can be programmed to employ search space directives that limit the sections of the search space searched for each query, which limiting can be referred to as “pruning the search space” which can include modifying the rule set. The search space directives can, for example, define boundaries of a search of the search space. The search space based, for example on resources cost parameters set by a cost control 22 of the DBMS 8 that ensures (or at least increases the chances) that the query optimizer 20 can find a query plan in the search space in a reasonable time based on the particular environment of implementation. In one example, the query optimizer 20 can include heuristics that can direct the query optimizer 20 to search the most promising members of the search space first. As one example, the resource cost parameters, such as processing time, memory, etc. of the query optimizer 20 can control limitations on a length (e.g., processing time) and/or depth of search. It is common, however, that the query optimizer 20, if given more processing resources (e.g., processing time) than those set by the cost control 22, could find a more efficient query plan. Moreover, the compiler 16 can determine a search space potential for the query plan, which can define the set of members of the search space that have been searched to find the query plan.

Upon determining the query plan (within the given resource constraints), the compiler 16 can generate a query plan template for the query plan. The query plan template can be implemented, by redacting literals of predicates from the query plan, such that the query plan template can be populated (e.g., filled) with variables in place of the redacted literals, which populated query plan template can be employed as a query plan in a manner described herein. Thus, the query plan template can be employed for a plurality of different queries.

The compiler 16 can provide the query plan to a query executor 24. The query executor 24 can employ the query plan to query the relational database stored in the data storage 10. Results of the query, typically in the form of data, can be provided to the query requestor 14. Additionally, an estimate execution resource cost of executing the query plan can be determined by the compiler 16. The compiler 16 can determine a search status for the query plan. A search status value indicating CONVERGED can indicate that the most efficient (or nearly the most efficient) query plan has likely been found for the received query. Moreover a search status value indicating NOT-CONVERGED can indicate that the most efficient (or nearly the most efficient) query plan has likely not been found for the received query, such that further searching of the search space is likely to result in a more efficient query plan being found for the received query. In the present example, the search status can be set to a value indicating NOT-CONVERGED since the search space has only been searched once.

Upon determination of the estimated execution resource cost, the compiler 16 can generate a query memento for the received query. In some examples, the generation of the query memento can occur before the query is executed, while in other examples, the generation of the query memento can occur after the query is executed. The query memento can characterize a state of the search space for the query cache key. The query memento can include, for example, the execution resource cost, defined by the estimated execution resource cost determined by the compiler 16, the rule set, the search space potential and the search status. The query memento can also include a search iteration field that defines the number of times that the search space for the received query has been searched. In the present example, since the search space has only been search once, the search iteration field can be set to a value of one. The compiler 16 can write a query cache entry to the query cache table 18. The compiler 16 can write a query cache entry to the query cache table 18 that includes the generated query cache key, the query plan template and the query memento.

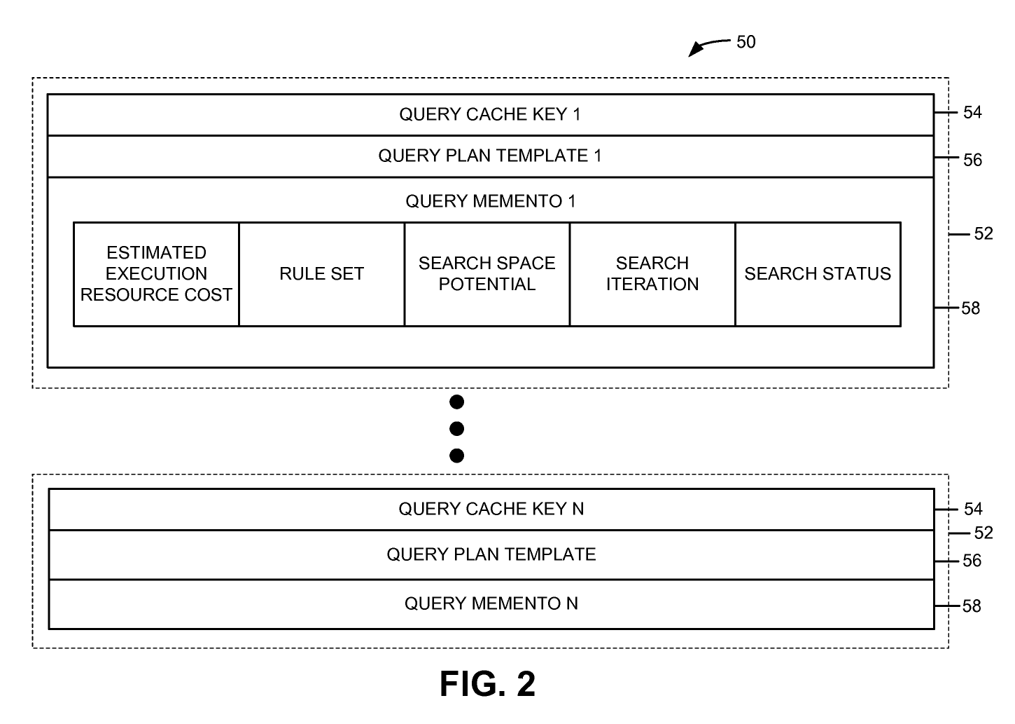

FIG. 2 illustrates an example of a query cache table 50, such as the query cache table 18 illustrated in FIG. 1. The query cache table 50 can be implemented with N number of query cache entry 52, where N is an integer greater than or equal to zero. Each query cache entry 52 can include a query cache key 54, labeled in FIG. 2 as “QUERY CACHE KEY” and a query plan. The query cache key 54 can be employed, for example, as a key field or index for the associated query cache entry 52. The query cache key 54 can be implemented in a manner similar to the generated query cache key described with respect to FIG. 1. Moreover, each query cache entry 52 can include a query plan template 56, labeled in FIG. 2 as “QUERY PLAN TEMPLATE.” The query plan template 56 can be implemented, for example, as a list of operations for performing a query, which operations are fillable with variables. In this manner, the same query plan template 56 can be employed for different queries by changing the variables. The variables could be implemented, for instance, with a literal/constant value of a predicate extracted from a query. The query plan template 56 can be generated for example, by a compiler (such as the compiler 16 illustrated in FIG. 1).

Each query cache entry 52 can further include a query memento 58, labeled in FIG. 2 as “QUERY MEMENTO.” The query cache entry 52 can include, for example, a execution resource cost, labeled in FIG. 2 as “ESTIMATED EXECUTION RESOURCE COST.” The estimated execution resource cost can characterize the estimated resource cost for executing a query based on the query plan template 56 of the query cache entry 52. As one example, the estimated execution resource cost can characterize a time and/or memory needed for execution of the query, etc. The query memento 58 can also include a rule set, labeled in FIG. 2 as “RULE SET” that can define a set of rules for generating a search space employed by a compiler (such as the compiler illustrated in FIG. 1) for generating the query plan template. The rule set can be employed to excluded regions of the search space, which excluded regions define regions in the search space that are unlikely to contain a query plan more efficient than a query plan corresponding to the query plan template of the query cache entry 52. The query memento 58 can further include a search space potential, labeled in FIG. 2 as “SEARCH SPACE POTENTIAL” that characterizes the sections of the search space that have been searched for the query cache entry 52. Still further, the query memento 58 can include a search iteration field, labeled in FIG. 2 as “SEARCH ITERATION” that defines the number of times the search space for the search corresponding to the query plan template has been searched. Still yet further, the query memento 58 can include a search status, labeled in FIG. 2 as “SEARCH STATUS” for the query cache entry 52.

Referring back to FIG. 1, at a subsequent time, the query input 12 can receive a second query from the query requestor 14, which second query can be forwarded to the compiler 16. As described herein, the compiler 16 can generate a second query cache key based on the second query. Moreover, the compiler 16 can access the query cache table 18 to determine if a stored query cache key has already been generated for the received query. The determination can be based, for example, on a comparison of the query cache key generated for the second query and query cache keys stored in query cache entries of the query cache table 18. If the compiler 16 determines that such a stored query cache key does exist, the compiler 16 can retrieve a query cache entry from the query cache table 18 that includes the stored query cache key, which query cache entry can be referred to as a retrieved query cache entry.

Upon receipt of the retrieved query cache entry, the compiler 16 can examine a search status of the query memento of the retrieved query cache entry. If the search status has a value indicating CONVERGE, the compiler 16 can populate the query plan template of the retried query cache entry with variables corresponding to predicate selectivity and/or literals extracted from the second query. Additionally, the compiler 16 can estimate a resource execution cost for executing a query based on the populated query plant template. The populated query plan template can be provided to the query executor 24, wherein the query executor 24 can execute a query on the relational database, as described herein. The query executor 24 can provide results of the query to the query requestor 14. The compiler 16 can update the estimated execution resource cost of the query memento of the retrieved query cache entry to reflect the newly determined estimated execution resource cost, such that the execution resource cost in the query memento of the retrieved query cache entry characterizes the most recent estimated execution resource cost that has been determined.

In the present example, if the search status of the query memento of the retrieved query cache entry has a value indicating NOT-CONVERGED, the compiler 16 can modify a rule set of a query memento of the retrieved query cache entry to enumerate (e.g., expand or augment) members in the search space. Stated differently, the modifications to the rule set can direct the compiler 16 to add a previously unsearched region of the search space, which unsearched region can be referred to as an expanded region of the search space. Additionally, the rule set can be modified such that excluded regions of the search space are not searched. Upon modifying the rule set, the compiler 16 can employ the query optimizer 20 to generate a second query plan by searching the expanded search space that can be generated based on the modified rule set. The second query plan can be provided to the query executor 24, which can search the database, as described above.

The compiler 16 can compare the estimated execution resource cost of the query memento stored in the retrieved query cache entry with an estimated execution resource cost corresponding to the second query plan and update the retrieved query cache entry based on the comparison, which can be referred to as a cost comparison. For instance, if the cost comparison indicates that the query plan template of the retrieved query cache entry is associated with a better (e.g., lower) execution resource cost than the estimated execution resource cost corresponding to the second query plan, the second query plan can be discarded, and the compiler 16 can again modify the rule set to exclude the expanded search space from future searches of the search space, which can define the aforementioned excluded regions, so that other expanded regions of the search spaces can be included in future searches. Additionally, the compiler 16 can update the search space potential of the query memento of the retrieved query cache entry to reflect the addition of the expanded region.

The compiler 16 can also increase the search iteration field of the query memento of the retrieved query cache entry by one to reflect the newly performed search of the search space. If the increased value of the search iteration field exceeds an iteration threshold set by the cost control 22, the search status of the query memento of the retrieved query cache entry can be set to a value indicating CONVERGED. The iteration threshold can be set to prevent an excessive number of searches of the same search space. Additionally or alternatively, the compiler 16 can set the search status of the query memento of the retrieved query cache entry to a value indicating CONVERGED if the compiler 16 determines that a percentage of the search space corresponding to the query cache key has been searched exceeds a search space region threshold set by the cost control 22. The search space region threshold can be set to prevent the search space from being searched when a certain percentage of the search space has already been searched. As one example, when all of the search space (e.g., 100%) has been searched, no further searching should be executed. Moreover, the compiler 16 can update the query cache table 18 such that the query memento of the retrieved query cache entry reflects the modifications to the rule set, the increase of the search iteration field and the possible change to the search status field.

If the cost comparison indicates that the estimated execution resource cost corresponding to the second query plan is less than the estimated execution resource cost of the query memento stored in the retrieved query, the compiler 16 can update the rule set of the query memento of the retrieved query cache entry to reflect the modifications expanding the search space and the search space potential can be updated to include the expanded regions of the search space. Additionally, the query plan template stored in the retrieved query cache entry can be replaced with a query plan template that is generated based on the second query, in a manner described herein. Moreover, the estimated execution resource cost of the query memento of the retrieved query cache entry can be updated to reflect the estimated execution resource cost corresponding to the second query.

Furthermore, based on the cost comparison, the compiler 16 can update (e.g., replace/overwrite) the execution resource cost of the query memento stored in the retrieved query cache entry with the estimated execution resource cost corresponding to the second query plan. Additionally, the compiler 16 can determine if the difference between the estimated execution resource cost corresponding to the second query plan and the estimated execution resource cost of the query memento stored in the retrieved query is less than a certain improvement threshold, which improvement threshold can set by the cost control 22, the search status of the query memento of the retrieved query cache entry can be set to a value indicating CONVERGED. For instance, the improvement threshold can be set to prevent continued searching of the search space beyond a point of diminishing returns. That is, the improvement threshold can be set to require a certain amount (e.g., a percentage) of improvement in the execution resource cost for a query for each search of the search space, or no further searching is performed.

Further still, if an improvement of the query memento is less than an expense (e.g., resource cost) of compiling the second query plan, the search status of the query memento of the retrieved query cache entry can be set to a value indicating CONVERGED. The improvement of the query memento can be defined by the difference between the estimated execution resource cost corresponding to the second query plan and the estimated execution resource cost of the query memento stored in the retrieved query)

The compiler 16 can also increase the search iteration field of the query memento of the retrieved query cache entry by one to reflect the new performed search of the search space. If the increased value of the search iteration field exceeds the iteration threshold, the search status of the query memento of the retrieved query cache entry can be set to a value indicating CONVERGED. Additionally or alternatively, the compiler 16 can set the search status of the query memento of the retrieved query cache entry to a value indicating CONVERGED if the compiler 16 determines the region threshold of the search space corresponding to the query cache key of the retrieved query cache entry has been exceeded. Moreover, the compiler 16 can update the query cache table 18 such that the query memento of the retrieved query cache entry reflects the modifications to the rule set, the change in the search space potential, the increase of the search iteration field and the possible change to the search status field.

By employing the DBMS 8, the resource cost of determining a substantially optimal (or optimal) query plan template for a given query cache key can be amortized (e.g., spread out) over multiple searches. Thus, the DBMS can employ iterative refinement to improve the performance of searches. Stated differently, the resource cost for searching an entire (or most of) a given search space for the given query can be shared among multiple searches. In this manner, response time for the given query can continue to improve each time that the given query is executed until a search status for the given query is set to a value indicating CONVERGE, which indicates that no further searching of the given search space is likely to result in a significant improvement in a query plan for the given query. Moreover, as noted above, the same query cache key and the same query plan template can be used for different queries (e.g., queries that vary by literal values and/or predicate selectivity values) received by the system 2. Accordingly, the resource costs for determining a substantially optimal (or optimal) query plan for a given query can be shared for multiple queries.

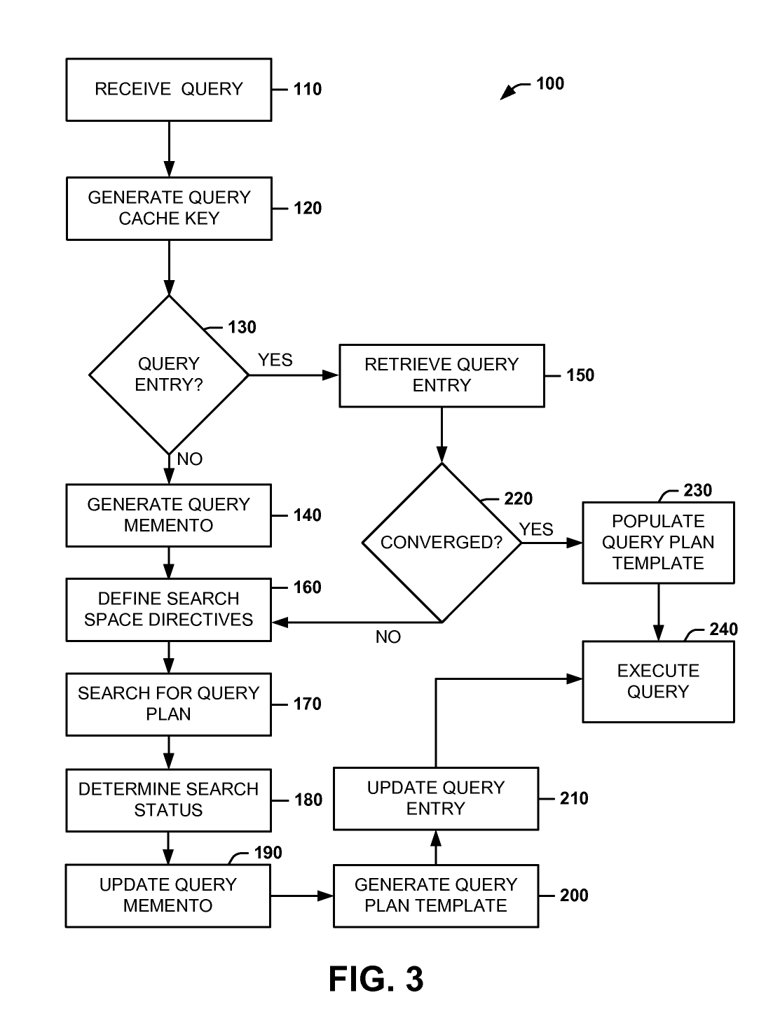

In view of the foregoing structural and functional features described above, example methodologies will be better appreciated with reference to FIGS. 3-5. While, for purposes of simplicity of explanation, the example methods of FIGS. 3-5 are shown and described as executing serially, it is to be understood and appreciated that the present examples are not limited by the illustrated order, as some actions could in other examples occur in different orders and/or concurrently from that shown and described herein.

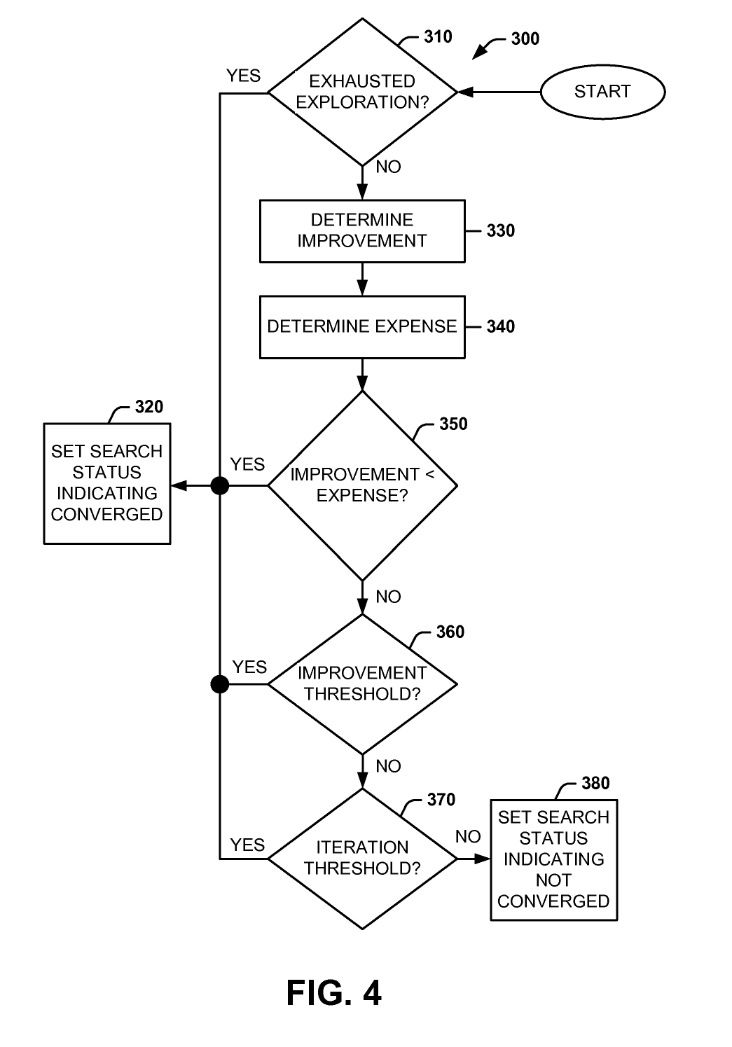

FIGS. 3-4 illustrate a flow chart of an example method 100 for managing a database. The method 100 could be executed, for example, by a DBMS. At 110, a query for a relational database can be received, for example, at a compiler of the DBMS. The query can be received, for example, at a query input of the DBMS and forwarded to the compiler of the DBMS. The query can be provided, for example, by an external application, such as a web browser operating on a computer external to the DBMS. At 120, a query cache key can be generated for the received query at the compiler in a manner described herein. At 130, the compiler can make a determination as to whether a query cache entry associated with the same query cache key as the generated query cache key is stored in a query cache table. If the determination at 130 is negative (e.g., NO), the method 100 can proceed to 140. If the determination at 130 is positive (e.g., YES), the method 100 can proceed to 150.

At 140, a query memento (such as the query memento 58 illustrated in FIG. 2) for the received query can be generated, in a manner described herein. At 160, search space directives (e.g., searching boundaries) for the received query can be defined. The search space directives can be based, for example, on the query memento as well as cost parameters set by a cost control of the DBMS. In some examples, defining the search space can include modifying the rule set of the query memento to include regions that have been previously unsearched. At 170, the search space can be searched, for example by a query optimizer of the compiler. The query optimizer can estimate which potential query plan in the search space has a lowest resource execution cost. At 180, a search status for the memento can be determined. At 190, the query memento can be updated to include the determined search status, an estimated cost for executing the query plan found in the search space. A search iteration field of the query memento can also be updated to reflect the number of times the search space has been searched, and a search space potential of the query memento can be updated to identify the sections of the search space that have been searched.

At 200, a query plan template can be generated for the query plan. The query plan template can be implemented as a fillable template with relational operators for executing a query on a database. In this manner, the query plan template can be reused for different queries. At 210, a query cache entry that includes the generated query cache key, the query plan template and the query memento can be updated/written to a query cache table, and the method 100 can proceed to 240.

At 150 the query cache entry can be retrieved by the compiler, and the method proceeds to 220. At 220, a determination can be made as to whether a search status of a query memento of the retrieved query cache entry has a value indicating CONVERGED. If the determination at 220 is positive (e.g., YES) the method 100 proceeds to 230. If the determination at 220 is negative (e.g., NO) the method 100 proceeds to 160.

At 230, a query plan template of the retrieved query cache entry can be populated with literals and/or predicate selectors extracted from the received query. The populated query plan template can be referred to as a query plan. At 240, a query executor of the DBMS can execute a query based on the query plan.

FIG. 4 illustrates an example of a method 300 for determining a search status for a query memento, such as the action 180 illustrated in FIG. 3. At 310, a determination is made as to whether exploration of the search space has been exhausted. The determination at 310 can be based, for example on a comparison of a search space potential of the query memento with a search space region threshold. If the determination at 310 is positive (e.g., YES), the method 300 can proceed to 320. If the determination is negative (e.g., NO), the method 300 can proceed to 330. At 320, the search status for the query memento can be set to a value indicating CONVERGED.

At 330 an improvement for the query memento can be determined. The improvement for the query memento can be based, for example, on a difference between an estimated resource execution cost of a pervious query plan and an estimated execution resource cost for a newly generated query plan. At 340, an expense for the query memento can be determined. The expense can be implemented, for examples as a query compilation cost (e.g., compilation time) for the newly generated query plan. At 350, a determination can be made as to whether the query memento improvement is less than the query memento expense. If the determination at 350 is positive (e.g., YES), the method 300 can proceed to 320. If the determination at 350 is negative (e.g., NO), the method can proceed to 360.

At 360, a determination can be made as to whether the determined improvement for the query memento is less than an improvement threshold. If the determination at 360 is positive (e.g., YES), the method 300 can proceed to 320. If the determination at 360 is negative (e.g., NO), the method 300 can proceed to 370.

At 370, a determination can be made as to whether a search iteration field is greater than an iteration threshold. If the determination is positive (e.g. YES), the method can proceed to 320. If the determination at 370 is negative, the method can proceed to 380. At 380, a search status field for the query memento can be set to a value indicating NOT-CONVERGED.

By utilizing the methods 100 and 300 illustrated in FIGS. 3-4, the resource cost for determining a substantially optimal query plan for a given set of queries that have the same query cache key can be amortized over multiple searches.

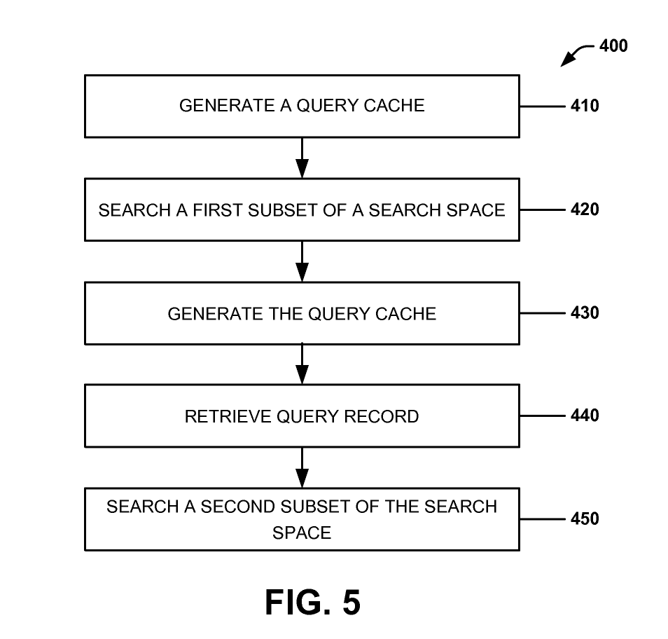

FIG. 5 illustrates another example of a method 400 for managing a database. At 410 a query cache key for a first received query can be generated. At 420 a first subset of a search space for a first query plan corresponding to the first received query can be searched. At 430 the query cache key can be generated for a second received query. At 440, a query cache entry can be retrieved from a query repository table. The query cache entry can be associated with a query cache key with the same value as the query cache key generated for the first and second received queries. At 450, a second subset of the search space for a second query plan corresponding to the first and second received queries can be searched. The second subset of the search space can contain more members than the first subset of the search space.

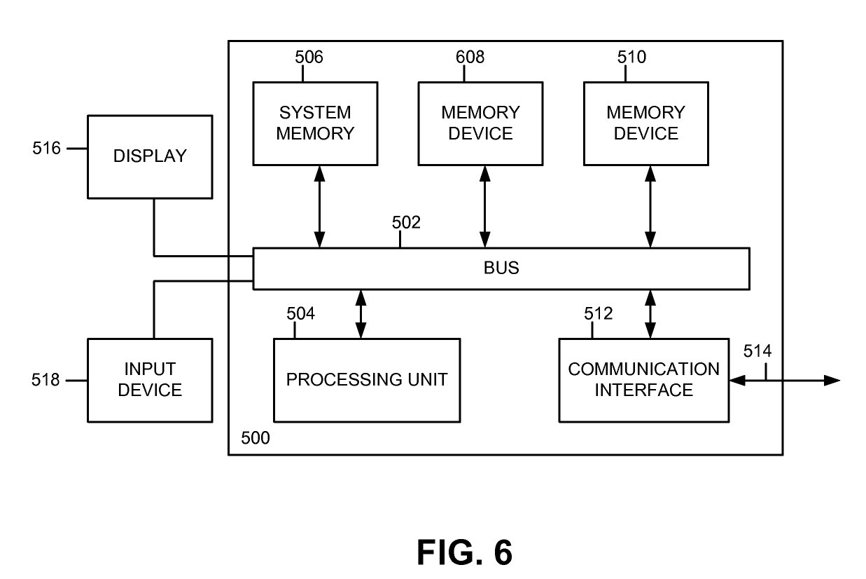

FIG. 6 is a schematic block diagram illustrating an exemplary system 500 of hardware components capable of implementing examples of systems and methods disclosed in FIGS. 1-5, such as the system 2 and/or the DBMS 8 illustrated in FIG. 1. The system 500 can include various systems and subsystems. The system 500 can be a personal computer, a laptop computer, a workstation, a computer system, an appliance, an application-specific integrated circuit (ASIC), a server, a server blade center, a server farm, etc.

The system 500 can includes a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard and/or a mouse). The system bus 502 can be in communication with the processing unit 504 and the system memory 506. The additional memory devices 508 and 510, such as a hard disk drive, server, stand alone database, or other non-volatile memory, can also be in communication with the system bus 502. The system bus 502 operably interconnects the processing unit 504, the memory devices 506-510, the communication interface 512, the display 516, and the input device 518. In some examples, the system bus 502 also operably interconnects an additional port (not shown), such as a universal serial bus (USB) port.

The processing unit 504 can be a computing device and can include an ASIC. The processing unit 504 executes a set of instructions to implement the operations of examples disclosed herein. The processing unit 504 can include a processing core. The additional memory devices 506, 508 and 510 can store data, programs, instructions, database queries in text or compiled form, and any other information that can be needed to operate a computer. The memories 506, 508 and 510 can be implemented as computer-readable media (integrated or removable) such as a memory card, disk drive, compact disk (CD), or server accessible over a network. In certain examples, the memories 506, 508 and 510 can comprise text, images, video, and/or audio.

Additionally, the memory devices 508 and 510 can serve as databases or data storage such as the data storage 10 illustrated in FIG. 1. Additionally or alternatively, the system 500 can access an external DBMS through the communication interface 512, which can communicate with the system bus 502 and the communication link 514.

In operation, the system 500 can be used to implement a DBMS that provides results in response to a plurality of database queries. The DBMS can receive the database queries in accordance with various query database protocols including SQL. Computer executable logic for implementing the DBMS resides on one or more of the system memory 506, and the memory devices 508, 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. A database management system comprising:
a memory for storing computer executable instructions; and
a processing unit for accessing the memory and executing the computer executable instructions, the computer executable instructions comprising:
a compiler to amortize an execution resource cost of searching a search space corresponding to a received query over a plurality of searches.

2. The database management system of claim 1, wherein the computer executable instructions further comprise a query cache table to store a query cache entry.

3. The database management system of claim 2, wherein the query cache entry comprises:
a query cache key that characterizes a query; and
a query memento that characterizes a search space state for the query cache entry;
wherein, the compiler is further to generate a query cache key based on the received query and to retrieve the query cache entry, wherein the query cache entry has an equivalent query cache key as the generated query cache key.

4. The database management system of claim 3, wherein the query cache entry further comprises a query plan template comprising relational operators and variables, such that the query plan template can be employed for a plurality of different queries

5. The database management system of claim 3, wherein the compiler is further to modify a rule set of the query memento of the query cache entry to generate an unsearched region of the search space, wherein the rule set includes rules for generating the search space for the received query.

6. The database management system of claim 3, the compiler is further to set a search status of the query memento of the query cache entry upon a determination by the compiler that a substantially optimal query plan for the received query has been found in the search space.

7. The database management system of claim 6, wherein the determination is based on at least one of a comparison of a search iteration field of the query memento of the query cache entry and an iteration threshold set by a cost control and a comparison of a search space potential of the query memento and a search space region threshold set by the cost control.

8. The database management system of claim 6, wherein the determination is based on a cost comparison between an estimated execution resource cost for the received query and an estimated execution resource cost stored in the query memento of the query cache entry.

9. The database management system of claim 8, wherein the search status is set to a value indicating CONVERGE if the cost comparison indicates a difference less than an improvement threshold set by a cost control.

10. A method for managing a database comprising:
generating a query cache key for a first received query;
searching a first subset of a search space for a first query plan corresponding to the first received query;
generating the query cache key for a second received query;
retrieving a query cache entry from a query repository table, wherein the query cache entry is associated with a query cache key with the same value as the query cache key generated for the first and second received queries; and
searching a second subset of the search space for a second query plan corresponding to the first and second received queries, wherein the second subset of the search space contains additional members than the first subset of the search space.

11. The method of claim 10, wherein the query cache entry comprises:
the query cache key; and
a query memento that characterizes a search space state for the query cache entry, the query memento comprising:
an estimated execution resource cost that characterizes an estimated cost of executing a query corresponding to the query cache key;
a rule set comprising logical rules for generating the search space;
a search space potential that defines the regions of the search space which have been previously searched;
a search iteration field that characterizes the number of times the search space has been searched;
a search status that characterizes whether a substantially optimal query plan corresponding to the query cache key has been determined.

12. The method of claim 10, wherein the second query plan is more efficient than the first query plan, such that query plan is iteratively refined over the searches of the first and second subsets of the search space.

13. A computer readable medium having computer executable instructions comprising a compiler of a database management system to iteratively refine a query plan template for a plurality of different queries over consecutive searches of a search space, wherein the search space defines a set of query plans for a given query cache key.

14. The computer readable medium of claim 13, wherein the compiler is further to store the plan template in a query memento of a query cache entry.

15. The computer readable medium of claim 14, wherein the compiler is further to employ the query plan template for queries having a same query cache key as the given query cache key.
